(19) United States
(12) Patent Application Publication
(10) Pub. No.: US 2017/0237162 A1
(43) Pub. Date: Aug. 17, 2017

(54) WIRELESS COMMUNICATION DEVICE AND ANTENNA ARRANGEMENT METHOD

(71) Applicant: FUJITSU LIMITED, Kawasaki-shi (JP)

(72) Inventor: Masahiko Shimizu, Kawasaki (JP)

(73) Assignee: FUJITSU LIMITED, Kawasaki-shi (JP)

(21) Appl. No.: 15/383,387

(22) Filed: Dec. 19, 2016

(30) Foreign Application Priority Data
Feb. 16, 2016 (JP) 2016-027366

(51) Int. Cl. H01Q 3/24; H01Q 21/22; H01Q 1/22

(52) U.S. Cl. CPC H01Q 3/24; H01Q 1/2291; H01Q 21/22

(57) ABSTRACT

A wireless communication device includes a plurality of antenna elements arranged in a row and M (M≧2) analog processing units that are connected to the antenna elements and that perform analog processing on signals received by or to be transmitted by the antenna elements. The antenna elements form subarrays such that antenna elements connected to a same analog processing unit form one subarray. Each of the antenna elements belonging to the formed M subarrays is arranged at a position (mM+k)d away from a reference antenna element arranged at one end of the row, where k (0≦k<M) is an integer that varies from one subarray to another subarray, m is an arbitrary integer, d is a predetermined unit spacing.

### CROSS-REFERENCE TO RELATED APPLICATION

This application is based upon and claims the benefit of priority of the prior Japanese Patent Application No. 2016-027366, filed on Feb. 16, 2016, the entire contents of which are incorporated herein by reference.

### FIELD

The embodiment discussed herein is related to a wireless communication device and an antenna arrangement method.

### BACKGROUND

Generally-known methods for controlling directional beams by using an array antenna formed by arranging a plurality of antenna elements in an array include an analog approach that uses a phased array and a digital approach that assigns a weight to each of the antenna elements by digital signal processing. The analog approach is advantageous in that, because only one analog circuit including a wireless circuit and a DA (digital-to-analogue)/AD (analogue-to-digital) converter suffices for the plurality of antenna elements, power consumption is relatively small. However, the analog approach is disadvantageous in that, because directional beams (hereinafter, simply referred to as “beams”) are formed in one direction, it is difficult to direct the beams to a plurality of users simultaneously. By contrast, with the digital approach, it is relatively easy to direct beams to a plurality of users simultaneously; however, the digital approach involves as many analog circuits as the number of the antenna elements and therefore disadvantageously consumes a relatively large amount of power.

Under the circumstances, in recent years, a hybrid approach that controls beams by combining the analog approach and the digital approach is proposed. The hybrid approach enables directing beams to a plurality of users simultaneously with less power consumption than with the digital approach. Specifically, the hybrid approach involves a plurality of analog circuits, each of which is connected to a plurality of antenna elements. Accordingly, because the number of analog circuits is smaller than the number of the antenna elements, reduction in power consumption as compared with the digital approach can be achieved. Furthermore, because as many data streams as the number of the analog circuits can be processed simultaneously, it is possible to direct beams to as many users as the number of the analog circuits simultaneously.

There are two schemes, i.e., a step-by-step scheme and an interleaving scheme, for connecting the analog circuits to the antenna elements in the hybrid approach. In the step-by-step scheme, a plurality of antenna elements adjacent to each other are connected to one analog circuit. By contrast, in the interleaving scheme, a plurality of antenna elements with other antenna elements interposed therebetween are connected to one analog circuit. Hereinafter, the plurality of antenna elements collectively connected to one analog circuit may be referred to as “subarray”.

[Patent Document 1] Japanese National Publication of International Patent Application No. 2015-521815

Because antenna elements within a subarray are compactly arranged in a narrow area with small spacings under the step-by-step scheme, the step-by-step scheme yields a wide beam width. By contrast, because antenna elements within a subarray are arranged over a wide area with large spacings under the interleaving scheme, the interleaving scheme yields a narrow wide width. Accordingly, when the step-by-step scheme is adopted to perform wireless communications with a plurality of users distributed within a narrow area, beams directed to the users undesirably overlap each other, making it difficult to separate the users. In this regard, when the interleaving scheme is adopted, even if users are distributed within a narrow area, because beams can be respectively directed to the users, it is possible to separate the users.

However, in the interleaving scheme, because other antenna elements are interposed between a plurality of antenna elements within a subarray, lines connecting the antenna elements to an analog circuit and lines of another subarray can cross. This can result in a problem that complexity of wiring connecting antenna elements to analog circuits is increased by skew in three dimensional geometry between, for example, lines of one subarray and lines of another subarray. The increase in complexity of wiring undesirably increases manufacturing cost of a wireless communication device including a plurality of antenna elements.

### SUMMARY

According to an aspect of an embodiment, a wireless communication device includes a plurality of antenna elements arranged in a row and M (M≧2) analog processing units that are connected to the antenna elements and that perform analog processing on signals received by or to be transmitted by the antenna elements. The antenna elements form subarrays such that antenna elements connected to a same analog processing unit form one subarray. Each of the antenna elements belonging to the formed M subarrays is arranged at a position (mM+k)d away from a reference antenna element arranged at one end of the row, where k (0≦k<M) is an integer that varies from one subarray to another subarray, m is an arbitrary integer, d is a predetermined unit spacing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a wireless communication device;

FIG. 2 is a diagram illustrating an example of connection via a switch;

FIG. 3 is a block diagram illustrating functions of a processor;

FIG. 4 is a diagram describing grouping of users;

FIG. 5 is a diagram illustrating an example of connection via the switch according to one embodiment;

FIG. 6 is a diagram illustrating antenna arrangement according to the one embodiment;

FIGS. 7(a) and (b) are diagrams illustrating a specific example of beam patterns; and

FIG. 8 is a flowchart illustrating a beamforming process according to the one embodiment.

### DESCRIPTION OF EMBODIMENT

Preferred embodiments of the present invention will be explained with reference to accompanying drawings. The embodiment is not intended to limit the scope of the present invention.

Prior to description of the wireless communication device and the antenna arrangement method according to the one embodiment, a configuration of a wireless communication device that controls beams using the hybrid approach is described.

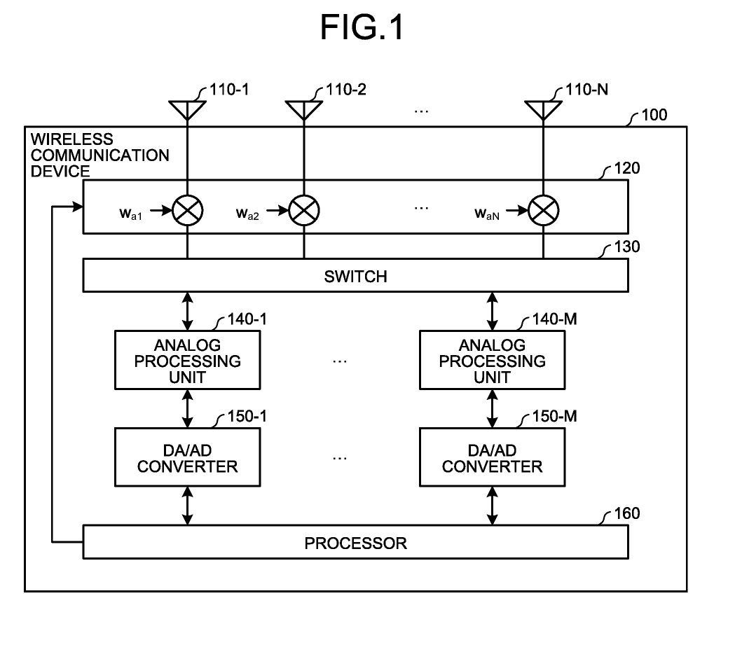

FIG. 1 is a block diagram illustrating a configuration of a wireless communication device 100 adopting the hybrid approach. The wireless communication device 100 illustrated in FIG. 1 includes antenna elements 110-1 to 110-N (N is an integer equal to or greater than 2), a phase shifter 120, a switch 130, analog processing units 140-1 to 140-M (M is an integer equal to greater than 2 but smaller than N), DA/AD converters 150-1 to 150-M, and a processor 160.

The antenna elements 110-1 to 110-N are linearly arranged in a row to form an antenna array. Generally, the antenna elements 110-1 to 110-N are equispaced. Spacing d between adjacent antenna elements may be set to, for example, half a wavelength λ of radio waves to be transmitted and received.

The phase shifter 120 assigns weights wₐ₁ to w_{aN} to the antenna elements 110-1 to 110-N to form a beam. Specifically, the phase shifter 120 forms the beam by using the weights wₐ₁ to w_{aN} fed from the processor 160. When a beam is directed at an angle of θ with respect to a direction perpendicular to an array direction, in which the antenna elements 110-1 to 110-N are arrayed, weights wₐₙ (n is an integer from 1 to N) can be expressed by Equation (1) below, for example.

$${W}_{an} = {e}^{j 2 π ( n - 1 ) \frac{d}{λ} sin θ} \qquad ( 1 )$$

In Equation (1) above, e is the base of natural logarithm, j is the imaginary unit, d is the spacing between adjacent antenna elements (hereinafter, “antenna-element spacing”), and λ is the radio wave wavelength. Assigning the weights wₐ₁ to w_{aN} to the antenna elements 110-1 to 110-N causes radio waves radiated from the antenna elements in the direction of θ or those incident on the antenna elements from the direction of θ to be in phase with each other. As a result, a beam is formed in the direction of θ.

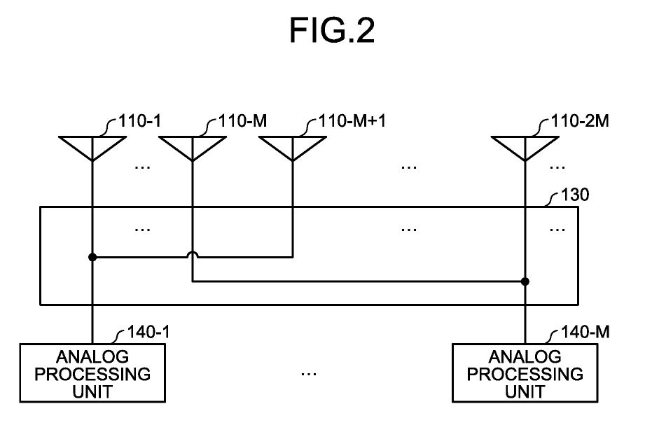

The switch 130 connects the antenna elements 110-1 to 110-N to the analog processing units 140-1 to 140-M. Specifically, the switch 130 connects a plurality of antenna elements belonging to one subarray to one analog processing unit. Accordingly, for example, when the interleaving scheme is adopted, as illustrated in FIG. 2, the switch 130 connects, as one subarray, the antenna element 110-1 and antenna elements spaced therefrom by M antenna elements to the analog processing unit 140-1 and connects, as one subarray, the antenna element 110-M and antenna elements spaced therefrom by M antenna elements to the analog processing unit 140-M. When generalized, the switch 130 connects the analog processing unit 140-i (i is an integer from 1 to M) to a subarray made up of antenna elements 110-(i+aM) (a is an integer equal to or greater than 0).

As illustrated in FIG. 2, the line connecting the antenna element 110-M+1 to the analog processing unit 140-1 and the line connecting the antenna element 110-M to the analog processing unit 140-M are skew. For this reason, wiring in the wireless communication device 100 adopting the interleaving approach is disadvantageously complicated. To alleviate this disadvantage, as will be described later, the present embodiment is configured to enable connecting antenna elements of each of subarrays to a corresponding analog processing unit without causing line skew by adjusting positions of the antenna elements of each of the subarrays.

Referring back to FIG. 1, the analog processing units 140-1 to 140-M apply predetermined analog processing to transmission signals and received signals. Specifically, the analog processing units 140-1 to 140-M amplify transmission signals by up-conversion or down-convert received signals, for example.

The DA/AD converters 150-1 to 150-M perform DA conversion on transmission signals and AD conversion on received signals. Specifically, the DA/AD converters 150-1 to 150-M perform DA conversion on transmission signals output from the processor 160 and output the thus-obtained analog signals to the analog processing units 140-1 to 140-M. The DA/AD converters 150-1 to 150-M perform AD conversion on received signals output from the analog processing units 140-1 to 140-M and outputs the thus-obtained digital signals to the processor 160.

The processor 160 estimates positions of users by performing direction-of-arrival estimation of signals received from the users, and calculates weights for directing beams respectively to the users. The processor 160 groups the users according to the positions of the users and determines weights for forming beams on a per-group basis.

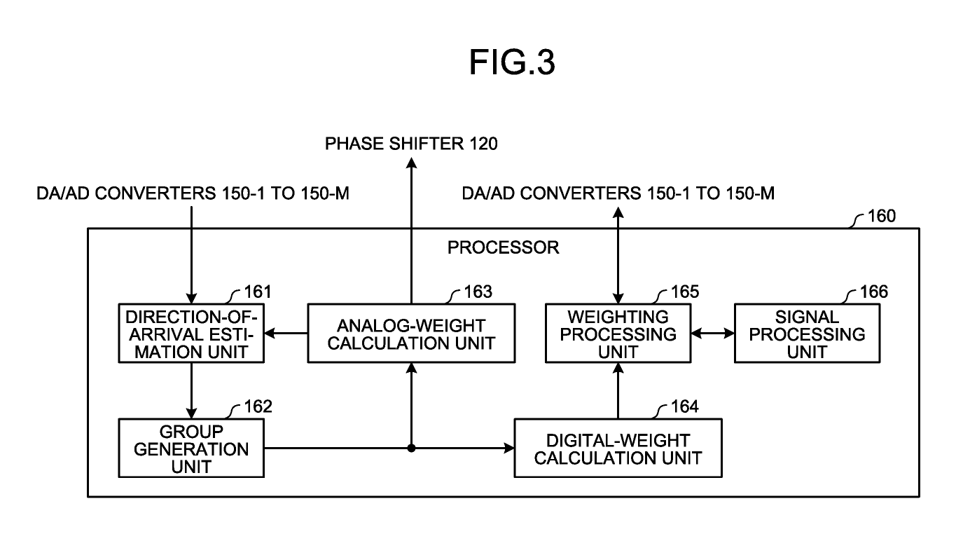

Specifically, as illustrated in FIG. 3, the processor 160 includes a direction-of-arrival estimation unit 161, a group generation unit 162, an analog-weight calculation unit 163, a digital-weight calculation unit 164, a weighting processing unit 165, and a signal processing unit 166.

The direction-of-arrival estimation unit 161 acquires signals that are received from a plurality of users and output from the DA/AD converters 150-1 to 150-M and estimates a direction of arrival of each of the received signals. Specifically, the direction-of-arrival estimation unit 161 estimates the direction of arrival of each of the received signals with the weights wₐ₁ to w_{aN} calculated by the analog-weight calculation unit 163 taken into account. More specifically, the direction-of-arrival estimation unit 161 acquires the weights wₐ₁ to w_{aN} to be assigned to the antenna elements 110-1 to 110-N from the analog-weight calculation unit 163 and estimates the directions of arrival of the received signals using the weights wₐ₁ to w_{aN}.

The direction-of-arrival estimation unit 161 calculates, as an angle indicating the direction of arrival of the received signal, an angle between the direction perpendicular to the array direction, in which the antenna elements 110-1 to 110-N are arrayed, and the direction of arrival of the received signal. Specifically, the direction-of-arrival estimation unit 161 calculates, as the direction of arrival of the received signal, an angle from zero degrees, i.e., an angle from the direction perpendicular to the array direction, in which the antenna elements 110-1 to 110-N are arrayed.

The group generation unit 162 groups the plurality of users based on the directions of arrival of the signals received from the users. For example, the group generation unit 162 may calculate maps pertaining to the directions of arrival of the received signals using a trigonometric function, such as sine (sin) and cosine (cos), and cause users corresponding to maps that satisfy a predetermined condition to belong to a same group. Specifically, the group generation unit 162 sets one user as a reference user, and causes each user corresponding to a map, the difference of which from a map pertaining to the reference user satisfies a predetermined condition, to belong to the same group as the reference user. The group generation unit 162 sequentially sets another user than the previous reference user as a reference user and repeatedly makes the determination as to whether or not a map pertaining to a user and a map pertaining to the reference user satisfy the predetermined condition until every user has belonged to any one of groups.

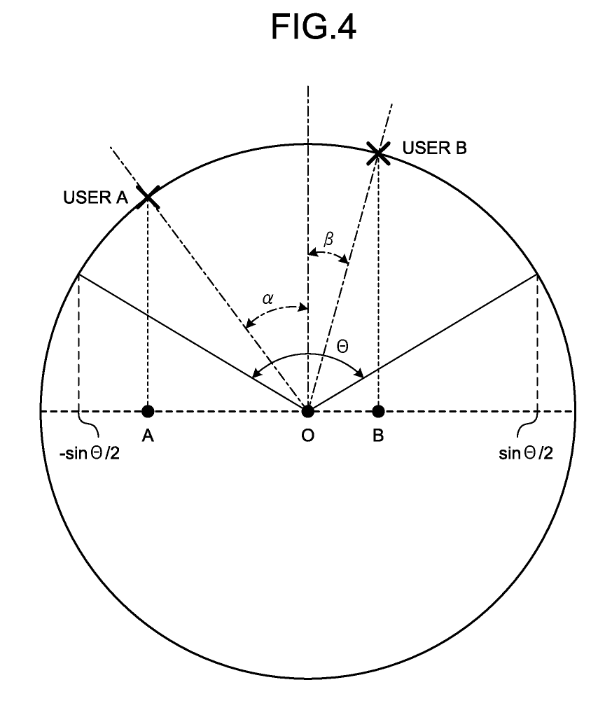

By virtue of that the group generation unit 162 groups users according to trigonometric function maps pertaining to directions of arrival of received signals in this manner, beams of sufficiently-high power level can be directed to the plurality of users simultaneously. The condition to be satisfied by a map pertaining to a user belonging to the same group as the reference user is described below with reference to FIG. 4.

FIG. 4 is a diagram schematically illustrating a point O where the wireless communication device 100 is located, and positions of a user A and a user B. In FIG. 4, the antenna elements 110-1 to 110-N of the wireless communication device 100, which is located at the point O, are arrayed in a lateral row. It is assumed that a range where beams can be formed (hereinafter, “beam-formable range”) by the antenna elements 110-1 to 110-N is the angle Θ in FIG. 4. Accordingly, sine maps of directions of beams to be formed in this range fall within a range from −sin Θ/2 to sin Θ/2.

Assume that an angle indicating the position of the user A is calculated as a by direction-of-arrival estimation of a received signal. In this case, a sine map pertaining to the user A is sin α. Hence, the point A in FIG. 4 is away from the point O by sin α. When the user A is set to the reference user, a map pertaining to the user B belonging to the same group as the user A satisfies Equation (2) below.

$$sin β = sin α + \frac{m}{M} \cdot 2 sin \frac{Θ}{2} \qquad ( 2 )$$

In Equation (2) above, β is an angle indicating the position of the user B. In Equation (2), m is an integer whose absolute value is equal to or smaller than M. As can be seen from Equation (2), spacing between sin α, which is the map pertaining to the reference user A, and sin β, which is the map pertaining to the user B, is an integral multiple of one part of M equal parts, into which a map of the beam-formable range is divided.

In Equation (2), M is the number of the analog processing units 140-1 to 140-M and is the number of the DA/AD converters 150-1 to 150-M included in the wireless communication device 100 and corresponds to the number of signals that can be transmitted/received simultaneously (hereinafter, “simultaneously-transceivable signals”). Accordingly, Equation (2) above tells that, in a sine map space, each user away from the reference user by a multiple of spacing, which is one part of equal parts, into which the beam-formable range is divided by the number of simultaneously-transceivable signals, is to belong to the same group as the reference user.

When the users are grouped in this manner, beams directed simultaneously to users within each of the groups are substantially identical in beam power level. The reason therefor is described below.

With regard to Equation (2) above, a weight w_{Aan} to be assigned to an antenna element 110-n to direct a beam to the user A can be obtained from Equation (1) and expressed as Equation (3) below.

$${w}_{Aan} = {e}^{j 2 π ( n - 1 ) \frac{d}{λ} sin α} \qquad ( 3 )$$

On the other hand, a weight w_{Ban} to be assigned to the antenna element 110-n to direct a beam to the user B belonging to the same group as the user A is expressed as Equation (4) below.

$${w}_{Ban} = {e}^{j 2 π ( n - 1 ) \frac{d}{λ} sin β} \qquad ( 4 )$$

The relation expressed by Equation (5) below holds among the spacing d of the antenna elements 110-1 to 110-N, the wavelength λ, and the beam-formable range Θ.

$$d = \frac{λ}{2 sin \frac{Θ}{2}} \qquad ( 5 )$$

Equation (6) below is obtained by substituting sin 3 of Equation (2) and d of Equation (5) into Equation (4) and rearranging the same.

$${w}_{Ban} = {w}_{Aan} \cdot {e}^{\frac{j 2 π ( n - 1 ) m}{M}} \qquad ( 6 )$$

By grouping users in this manner, weights to be assigned to the antenna elements to direct beams respectively to the users can be expressed using weights to be assigned to the antenna elements to direct a beam to the reference user.

Furthermore, when attention is focused on j2π(n−1)m/M, which is a phase-related portion, of Equation (6), difference of the phase-related portion between the weight w_{Ban} for the antenna element 110-n and a weight w_{Ba(n+M)} for an antenna element 110-(n+aM) (a is an integer equal to or greater than 0) is a multiple of 2π. Accordingly, antenna elements spaced at intervals of M antenna elements are in phase with each other and, accordingly, weights for a plurality of antenna elements connected to a same analog processing unit by the interleaving scheme have a same phase.

Thus, grouping users as described above makes it possible to assign weights of a same phase to signals to be processed by a corresponding one of the analog processing units 140-1 to 140-M.

The analog-weight calculation unit 163 calculates weights wₐ₁ to w_{aN} to be used by the phase shifter 120 for each of the user groups generated by the group generation unit 162. Specifically, the analog-weight calculation unit 163 calculates, for each of the groups, the weights wₐ₁ to w_{aN} for forming a beam directed to the reference user of the group. Put another way, the analog-weight calculation unit 163 calculates weights w_{Aan} for the reference user A of Equation (6). The analog-weight calculation unit 163 feeds the calculated weights wₐ₁ to w_{aN} to the phase shifter 120 and also to the direction-of-arrival estimation unit 161.

The digital-weight calculation unit 164 calculates, for each of the user groups generated by the group generation unit 162, weights for use in weighting digital signals for each of users of the group. Specifically, the digital-weight calculation unit 164 calculates weights corresponding to a difference in direction from the reference user for each of the users. Put another way, the digital-weight calculation unit 164 calculates weights corresponding to the exponent of e of Equation (6) for each of the users.

The weighting processing unit 165 weights signals of each of users of each of the groups using the weights calculated by the digital-weight calculation unit 164. Specifically, the weighting processing unit 165 multiplies signals to be fed to the DA/AD converters 150-1 to 150-M or signals output from the DA/AD converters 150-1 to 150-M by weights calculated for each of the users.

The signal processing unit 166 generates transmission signals by encoding and modulating data to be transmitted to users or demodulates and decodes received signals received from users. At this time, the signal processing unit 166 may generate transmission signals to be transmitted to the users collectively, for example, on a per-group basis according to groups, into which the users are grouped by the group generation unit 162. The signal processing unit 166 may produce a schedule that causes the users to transmit signals simultaneously to the wireless communication device 100 on a per-group basis according to the groups, into which the users are grouped by the group generation unit 162, and generate a control signal for sending the produced schedule to each of the users.

It is possible to direct beams of sufficiently-high power level to a plurality of users simultaneously by connecting the antenna elements 110-1 to 110-N to the analog processing units 140-1 to 140-M by the interleaving scheme and grouping the users according to trigonometric function maps of directions of arrival of received signals in this manner. However, as described earlier, when connected with the interleaving scheme, lines connecting the antenna elements 110-1 to 110-M to the analog processing units 140-1 to 140-M are skew, making wiring complicated. To alleviate this disadvantage, in the present embodiment, arrangement of the antenna elements 110-1 to 110-N is adjusted, thereby reducing an increase in complexity of wiring while maintaining beam quality.

The wireless communication device 100 according to one embodiment is similar in configuration to the wireless communication device 100 illustrated in FIG. 1, and repeated description is omitted. However, in the present embodiment, connection via the switch 130 between the antenna elements 110-1 to 110-M and the analog processing units 140-1 to 140-M is made differently from that by the interleaving scheme illustrated in FIG. 2.

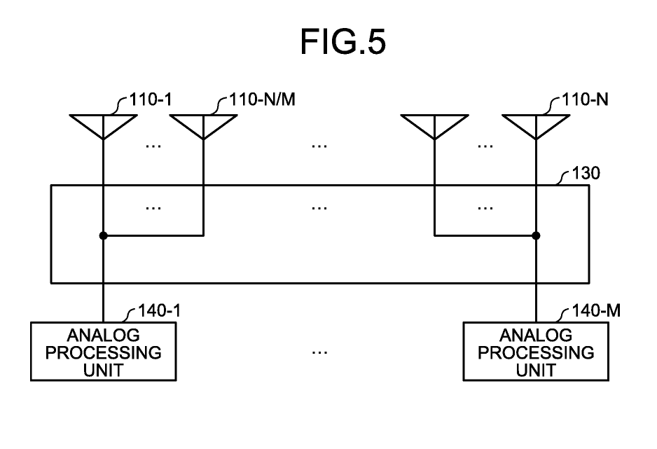

FIG. 5 is a diagram illustrating an example of connection via the switch 130 according to the one embodiment. As illustrated in FIG. 5, the switch 130 connects, for example, the analog processing unit 140-1 to N/M antenna elements that are continuously arranged from the antenna element 110-1 and connects the analog processing unit 140-M to N/M antenna elements that are continuously arranged to the antenna element N. Specifically, the switch 130 connects, among the antenna elements 110-1 to 110-N, N/M antenna elements that are adjacent to each other and that form one subarray to a same analog processing unit, which is one of the analog processing units 140-1 to 140-M. Note that the switch 130 connects the antenna elements 110-1 to 110-N, which are not equispaced, to the analog processing units 140-1 to 140-M.

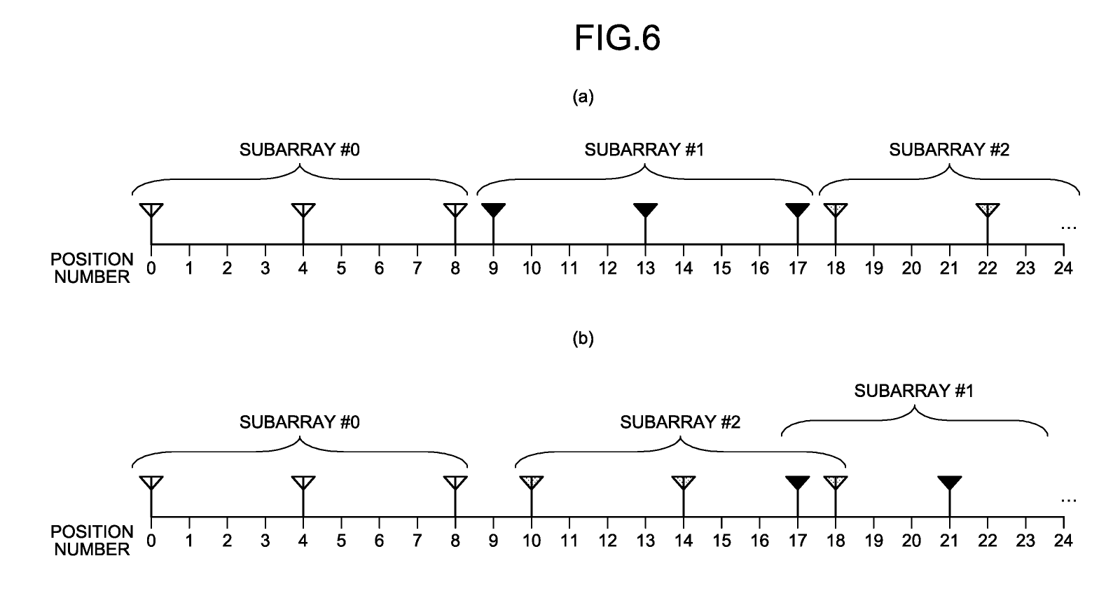

Arrangement of the antenna elements according to the one embodiment is specifically described below with reference to FIG. 6.

In the present embodiment, antenna-element spacing within one subarray is larger than the spacing d, which is half the wavelength λ of radio waves to be transmitted/received. Specifically, the antenna-element spacing within one subarray is an M multiple of the spacing d, where M is the number of subarrays. Accordingly, when, for example, the antenna elements 110-1 to 110-N are divided into four subarrays and antenna elements in the subarrays are connected to the analog processing units 140-1 to 140-4, antenna-element spacing in each of the subarrays is 4d. This spacing is equal to that of subarrays connected to the analog processing units 140-1 to 140-M by the interleaving scheme. However, in the present embodiment, because an antenna element belonging to another subarray is not interposed between antenna elements within one subarray, line skew will not appear.

Spacing between different subarrays is defined by positions where the subarrays are allowed to be located. Specifically, when positions spaced at regular intervals of the spacing d, which is a unit spacing, are sequentially numbered from an end, the antenna elements within each of the subarrays are arranged at positions, to which position numbers that vary from one subarray to another subarray in the remainder on division by M, the number of subarrays, are assigned. Accordingly, when, for example, the number of subarrays is 4, the antenna elements within one subarray are arranged at positions, to which position numbers that give 0 as the remainder on division by 4 are assigned; the antenna elements within another subarray are arranged at positions, to which position numbers that give 1 as the remainder on division by 4 are assigned; the antenna elements within still another subarray is arranged at position, to which position numbers that give 2 as the remainder on division by 4 are assigned; and the antenna elements within the other one subarray are arranged at positions, to which position numbers that give 3 as the remainder on division by 4 are assigned.

Specifically, for example, assume a case where 12 antenna elements (110-1 to 110-12) are divided into 4 subarrays, which are respectively connected to the analog processing units 140-1 to 140-4. In this case, as illustrated in (a) of FIG. 6 for example, antenna elements belonging to one subarray #0 are arranged at positions, to which position numbers 0, 4, and 8 each giving 0 as the remainder on division by the number of subarrays 4, among position numbers spaced at regular intervals of the unit spacing d, are assigned. Antenna elements belonging to one subarray #1 are arranged at positions, to which position numbers 9, 13, and 17 each giving 1 as the remainder on division by the number of subarrays 4 are assigned. Antenna elements belonging to one subarray #2 are arranged at positions, to which position numbers 18, 22, and 26 each giving 2 as the remainder on division by the number of subarrays 4 are assigned.

Thus, the antenna-element spacing in each of the subarrays is 4d, which is equal to the product of the unit spacing d and the number of subarrays; the antenna elements of the subarrays are arranged at positions that vary from one subarray to another in the remainder of dividing the position number by the number of subarrays 4. Antenna elements belonging to one subarray are desirably arranged at positions, to which position numbers larger than the largest one of position numbers where antenna elements belonging to another subarray are arranged, are assigned. As a result, because a situation that antenna elements belonging to another subarray are interposed between antenna elements within one subarray is avoided, connection illustrated in FIG. 5 having no skew lines can be achieved. Put another way, reduction in an increase in complexity of wiring while maintaining beam quality can be achieved.

In the example described above, arrangement of the antenna elements other than that illustrated in (a) of FIG. 6 can be employed so long as the antenna elements in the subarrays are arranged at positions that vary from one subarray to another in the remainder of dividing the position number by the number of subarrays 4. For example, as illustrated in (b) of FIG. 6, the antenna elements belonging to the one subarray #1 may be arranged at positions, to which position numbers 17, 21, and 25 each giving 1 as the remainder on division by 4, the number of subarrays, are assigned, and the antenna elements belonging to the one subarray #2 may be arranged at positions, to which position numbers 10, 14, and 18 each giving 2 as the remainder on division by 4, the number of subarrays, are assigned.

In this case, the antenna element at the position of the position number 17 belonging to the subarray #1 is interposed between the antenna elements at the positions of the position numbers 14 and 18 belonging to the subarray #2. Accordingly, lines connecting between the antenna elements and the analog processing units will be skew. However, because the number of positions where lines are skew is smaller than that of the interleaving scheme, an increase in complexity of wiring can be reduced.

As described above, in the antenna arrangement according to the present embodiment, when k (k is an integer equal to or greater than 0 and smaller than M, the number of subarrays) that varies from one subarray to another subarray is given, antenna elements in the subarrays are arranged at the (mM+k)^{th} (m is an arbitrary integer) positions from the end of the positions spaced at regular intervals of the unit spacing d. Put another way, each of the antenna elements belonging to the subarrays is arranged at a position away from a reference antenna element, which is arranged at the one end, the (mM+k)d, where k is an integer that is equal to or greater than 0 and smaller than M, the number of subarrays, and that varies from one subarray to another.

It is desirable that the antenna-element spacing in each of the subarrays is an M multiple of the spacing d, where M is the number of subarrays. Furthermore, it is desirable that every antenna element belonging to one subarray of two different subarrays is arranged farther away from the reference antenna element than every antenna element belonging to the other subarray. When arranged in this manner, antenna-element spacing within each of the subarrays differs from antenna-element-to-antenna-element spacing between different subarrays, and the plurality of antenna elements are arranged non-equidistantly. Furthermore, because skew lines at the switch 130 can be avoided, an increase in complexity in wiring can be reduced.

By setting the antenna-element spacing within the subarrays to the product of the unit spacing d and the number of subarrays, as can be seen from Equation (6), weights for the antenna elements within a subarray have a phase interval of 2π. Furthermore, by arranging the antenna elements of each of the subarrays at positions, to which position numbers that vary from one subarray to another in the remainder on division by the number of subarrays, are assigned, weights of the antenna elements have phases that vary from one subarray to another and that have the phase interval of 2π. As a result, when beams are to be formed simultaneously in the direction of α and the direction of β, where α and α are the angles that satisfy Equation (2), a main beam of one of the beam patterns is formed in a null direction of the other beam pattern.

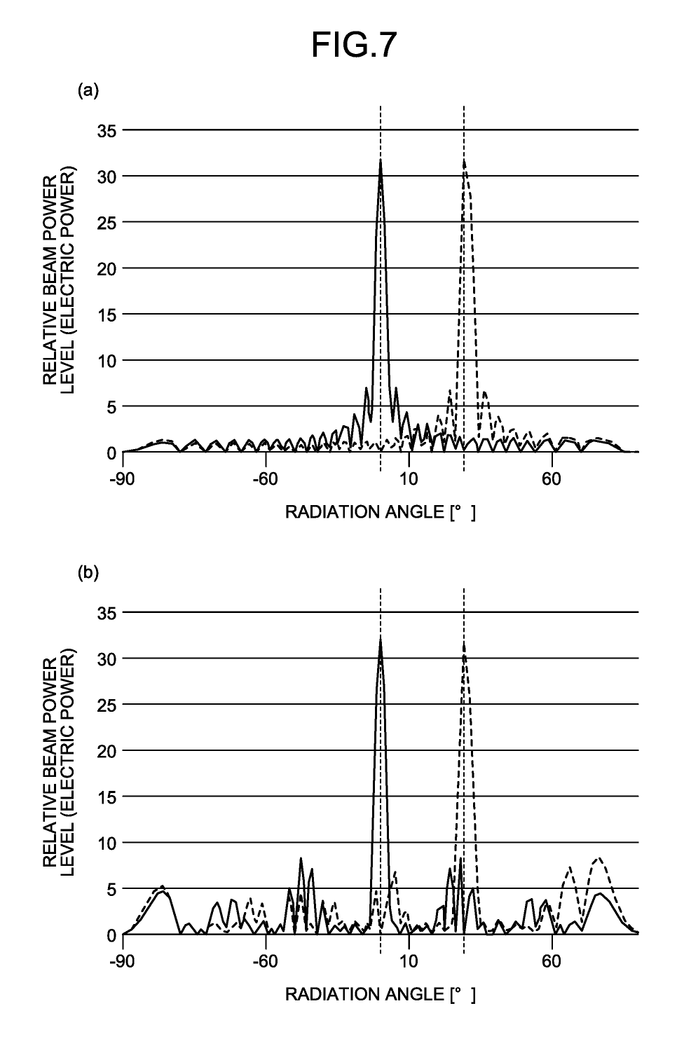

A diagram illustrating beam patterns obtained when the antenna elements 110-1 to 110-M and the analog processing units 140-1 to 140-M are connected by the above-described interleaving scheme is presented in (a) of FIG. 7. As illustrated in (a) of FIG. 7, a main beam of one of the beam patterns is formed in a null direction of the other beam pattern. Specifically, the main beam directed to one user is formed in the direction where a grating lobe pertaining to the other user is not formed. Accordingly, a beam of sufficiently-high power level can be directed to each of the users.

A diagram illustrating beam patterns obtained when the antenna elements 110-1 to 110-M arranged in the antenna arrangement according to the present embodiment are connected to the analog processing units 140-1 to 140-M is presented in (b) of FIG. 7. As illustrated in (b) of FIG. 7, power level of a main beam in each of the directions is similar to that of the connection by the interleaving scheme; a main beam of one of the beam patterns is formed in a null direction of the other beam pattern. Put another way, even when the antenna elements 110-1 to 110-M and the analog processing units 140-1 to 140-M are connected in a manner not to have skew lines, beams that are equivalent in quality to those obtained using the above-described interleaving scheme can be formed.

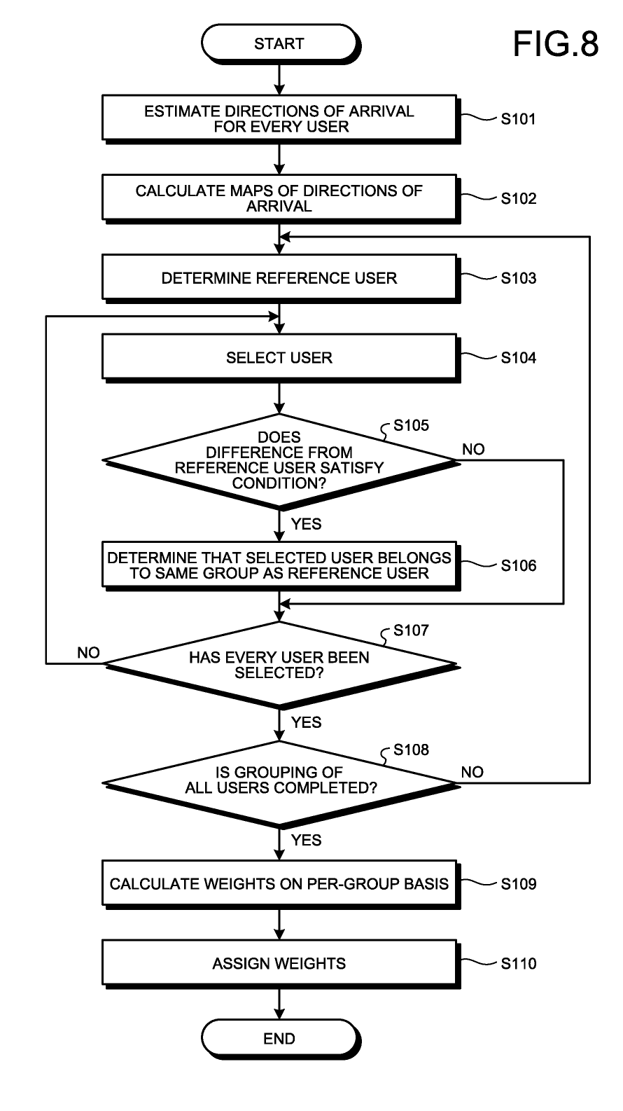

A beamforming process performed by the wireless communication device 100 configured as described above is described below with reference to a flowchart illustrated in FIG. 8.

Upon receiving signals transmitted from a plurality of users, with which communications are to be performed, the wireless communication device 100 estimates directions of arrival of the received signals for every user (S101). Specifically, the received signals received by the antenna elements 110-1 to 110-N are down-converted by the analog processing units 140-1 to 140-M and AD-converted by the DA/AD converters 150-1 to 150-M. The thus-obtained digital received signals are fed to the direction-of-arrival estimation unit 161 of the processor 160. The direction-of-arrival estimation unit 161 estimates the directions of arrival of the received signals with the weights wₐ₁ to w_{aN} set to the phase shifter 120 taken into account. Specifically, the direction-of-arrival estimation unit 161 estimates, as the directions of arrival, angles from 0 degrees, i.e., from the direction perpendicular to the array direction, in which the antenna elements 110-1 to 110-N are arrayed. The angles estimated in this manner are the angles indicating positions of the respective users.

The group generation unit 162 calculates, for each of the users, a sine map of the angle indicating the position of the user (S102). The group generation unit 162 groups the users. By this grouping, users, transmission or reception from or by which is to be performed simultaneously, are caused to belong to a same group.

Specifically, the group generation unit 162 sets any one of not-yet-grouped users as a reference user (S103). Thereafter, another one of the not-yet-grouped users is selected (S104), and a difference between a map pertaining to the selected user and a map pertaining to the reference user is calculated. When the difference has been calculated, whether or not the difference satisfies a predetermined condition is determined (S105). When the condition is satisfied (Yes at S105), it is determined that the selected user belongs to the same group as the reference user (S106).

The condition for use in determining whether or not the selected user belongs to the same group as the reference user may be as follows. When, in a sine map space, the difference between the map pertaining to the reference user and the map pertaining to the selected user is approximately equal to a multiple of the spacing, which is one of equal parts, into which the beam-formable range is divided by M, where M is the number of the analog processing units 140-1 to 140-M, the reference user and the selected user belong to a same group. Put another way, when sin α is given as the map pertaining to the reference user and sin β is given as the map pertaining to the selected user, if sin β satisfies Equation (2), the reference user and the selected user belong to a same group.

After the determination as to whether or not the selected user belongs to the same group as the reference user is made in this manner, whether or not every one of the not-yet-grouped users has been selected is determined (S107). When it is determined that there is a not-yet-selected user(s) (No at S107), any one of the not-yet-selected user(s) is selected (S104), and determination as to whether or not the selected user belongs to the same group as the reference user is made in a manner similar to that described above.

When it is determined every user has been selected (Yes at 6107), whether or not every one of the users belongs to the same group as any one of the reference users and grouping of all the users is completed is determined (S108). When it is determined that there is a user(s) belonging to none of the groups (No at 3107), any one of such user(s) is set as a reference user (3103), and determination as to whether or not a user belongs to the same group as the reference user is made for each of the users in a manner similar to that described above.

When such grouping has been performed by the group generation unit 162 and all the users have been grouped (Yes at S108), each of the analog-weight calculation unit 163 and the digital-weight calculation unit 164 calculates weights on a per-group basis (S109). The weights wₐ₁ to w_{aN} calculated by the analog-weight calculation unit 163 on a per-group basis are output to the phase shifter 120 to be assigned to the antenna elements 110-1 to 110-N, respectively. The weights calculated by the digital-weight calculation unit 164 on a per-group basis are output to the weighting processing unit 165 to be set on a per-user basis in each of the groups (S110).

Thereafter, signals are transmitted/received on a per-group basis such that, when signals of one group are transmitted/received, weights for the one group are set to the phase shifter 120 and the weighting processing unit 165. As a result, because beams directed to the users are substantially identical in power level, beams of sufficiently-high power level can be directed to the plurality of users simultaneously.

As described above, according to the present embodiment, antenna-element spacing within a subarray is set to the product of the unit spacing d and the number of subarrays; antenna elements in each of subarrays are arranged at positions, to which position numbers that, among position numbers spaced at regular intervals of the unit spacing d, vary from one subarray to another subarray in the remainder on division by the number of subarrays are assigned. With this configuration, even when a plurality of antenna elements belonging to one subarray and continuously arranged are connected to a same analog processing unit, it is possible to direct beams having sufficiently-high power level to a plurality of directions. Hence, reduction in an increase in complexity of wiring while maintaining beam quality can be achieved.

According to an aspect of the present invention, a wireless communication device and an antenna arrangement method that enable reducing an increase in complexity of wiring while maintaining beam quality are provided.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless communication device comprising:
a plurality of antenna elements arranged in a row; and
M (M≧2) analog processing units that are connected to the antenna elements and that perform analog processing on signals received by or to be transmitted by the antenna elements, wherein
the antenna elements form subarrays such that antenna elements connected to a same analog processing unit form one subarray, and
each of the antenna elements belonging to the formed M subarrays is arranged at a position (mM+k)d away from a reference antenna element arranged at one end of the row, where k (0≦k<M) is an integer that varies from one subarray to another subarray, m is an arbitrary integer, d is a predetermined unit of spacing.

2. The wireless communication device according to claim 1, wherein the antenna elements are arranged at intervals of Md in each of the subarrays.

3. The wireless communication device according to claim 1, wherein the antenna elements are arranged such that every antenna element belonging to one subarray of two different subarrays is arranged farther away from the reference antenna element than every antenna element belonging to the other subarray is.

4. The wireless communication device according to claim 1, further comprising a processor that forms directive beams using the antenna elements, wherein the processor executes a process including:
estimating directions of arrival of signals transmitted from a plurality of users;
calculating maps, using a trigonometric function, of angles indicating the estimated directions of arrival;
grouping the users according to the calculated maps; and
determining, for each of the groups obtained by the grouping, weights for forming beams directed to the users belonging to the group.

5. An antenna arrangement method for a wireless communication device including M (M≧2) analog processing units that perform analog processing on signals, the antenna arrangement method comprising:
arranging a reference antenna element at one end of a row formed by arranging a plurality of antenna elements; and
arranging each of antenna elements connected to a same analog processing unit at a position (mM+k)d away from the reference antenna element, where k (0≦k<M) is an integer that varies from one analog processing unit to another analog processing unit, m is an arbitrary integer, d is a predetermined unit of spacing.
